(19) United States
(12) Patent Application Publication
(10) Pub. No.: US 2024/0060713 A1
(43) Pub. Date: Feb. 22, 2024

(54) DOMESTIC APPLIANCE HAVING A CAMERA AND A POSITIONALLY FIXED ARRANGEMENT OF A MODULE IN A HOUSING SLOT OF THE CAMERA, AND METHOD

(71) Applicant: BSH Hausgeräte GmbH, München (DE)

(72) Inventors: Daniel Bihr, Kirchheim am Ries (DE); Stephan Kempfle, Ellzee (DE); Christopher Rodney, Villenbach (DE); Joachim Schäferling, Bissingen (DE)

(21) Appl. No.: 18/259,629

(22) PCT Filed: Jan. 12, 2022
(86) PCT No.: PCT/EP2022/050517

§ 371 Date: Jun. 28, 2023

(30) Foreign Application Priority Data
Jan. 20, 2021 (DE) 10 2021 200 495.4

(51) Int. Cl. F25D 29/00; F25D 23/06

(52) U.S. Cl. CPC F25D 29/005; F25D 23/067

(57) ABSTRACT

A household appliance has a camera with a housing and a module with a first electrical connector. The module is separate from the housing and arranged in the housing. The housing is formed with a housing slot with a longitudinal axis, and a positioning device is arranged on an inner side of the housing slot. The module is arranged in the housing slot and is arranged so as to be at least axially fixed in the housing slot by a positioning device. There is also described a method for mounting a camera of a household appliance.

One aspect of the invention relates to a household appliance having a camera. The camera has a housing. The camera also has a module that is separate from the housing. Said module has a first electrical connector. Said electrical connector is configured to make contact with a further electrical connector external to the camera. The module is arranged in the housing of the camera. A further aspect of the invention relates to a method for mounting a camera of a household appliance.

It is known for at least one camera to be present in modern household appliances, for example household refrigeration appliances, said camera being used to capture a chamber for food. It is known for such a camera to be arranged for example on a wall of an inner container that delimits the chamber in household refrigeration appliances. As household refrigeration appliances require thermal insulation between the inner container and the outer housing of the household refrigeration appliance, attachment in this manner is more problematic. To allow it, a backing part is used in addition to a camera. This is generally arranged in a space between the inner container and the outer housing. The backing part is therefore arranged in particular where there is foam. This means that it is arranged in the space between the inner container and the outer housing, into which thermally insulating foam is introduced. Such a configuration is known for example from DE 10 2013 216 767 A1. Such a backing part is snap-fitted in a cut-out in a wall of the inner container. A support for a camera housing and a lighting unit is also inserted into the backing part there and snap-fitted thereto. Connecting interfaces present for the electrical connection of the camera are integrated in a rear wall of the backing part or passed into the interior of the backing part by means of a cable.

In the case specifically of compactly structured cameras, which are to be arranged in a space-saving manner in a household appliance, the individual components should be arranged in a defined manner in relation to one another.

It is the object of the present invention to create a household appliance, in which a camera with its individual components is structured in such a manner that it is possible to achieve simple and secure coupling to components external to the camera in a simple and reliable manner. It is also an object to create a method for mounting a camera of a household appliance, in which such simple coupling to components external to the camera is subsequently then possible.

Said object is achieved by a household appliance and a method as set out in the independent claims.

One aspect of the invention relates to a household appliance. The household appliance has at least one camera. The camera has a housing. The camera also has a module that is separate from the housing. Said module has a first electrical connector. It can also be referred to as a connector module. This is specifically provided to allow direct coupling of the first electrical connector to a separate second electrical connector external to the camera. This module of the camera is arranged in the housing. In particular it is arranged in its totality therein. The housing has a housing slot. Said housing slot has a longitudinal axis. A positioning device is arranged on an inner face of said housing slot. The module of the camera is arranged in said housing slot. The positioning device arranges the module in the housing slot such that it is fixed at least axially and therefore at least in the direction of the longitudinal axis of the housing slot. This means that a relatively central component of the camera, specifically the first electrical connector, is positioned precisely in said housing slot. This allows simple coupling to a further electrical connector external to the camera in a simple and secure manner. This also reliably ensures the electrical connection between the camera and external components. Particularly when said first electrical connector is arranged in its totality within the housing slot and held therein in a fixed position relative thereto, the first electrical connector can also be reliably connected blind to the second electric connector external to the camera when the camera is mounted on a further component of the household appliance. Mechanical and electrical contacts are then reliably established with said blind connection. Because of said positioning device, which is arranged on the housing slot on an inner face, the end position of the module in the housing slot is automatically reached and then maintained in a fixed manner, when the module is inserted. As the housing slot is only open in particular at its opposing ends when viewed along the longitudinal axis, inward accessibility is limited. This makes positioning difficult when inserting the electrical connector into the housing slot. The invention with the positioning device resolves this problem even for such difficult to access installation positions and also end positions of the electrical connector that are difficult to locate reliably. Even if it is not possible to see a great deal in the housing slot or to achieve access, the positioning device allows the desired end position of the module in the housing slot to be reached and maintained precisely. Specifically if the housing slot is also to be connected mechanically and/or brought into contact in a direct manner with further components of the household appliance and said electrical connectors are therefore to be connected directly, such a precise axial position of the module in the housing slot is particularly advantageous. Account can therefore be taken of all aspects in respect of the direct coupling of multiple component pairs, allowing particularly precise and therefore fast and simple installation of the camera on components of the household appliance.

In one exemplary embodiment the module has a printed circuit board. Said printed circuit board is connected mechanically in a direct manner to the positioning device so that the printed circuit board is arranged in an axially fixed manner in the housing slot. The printed circuit board per se is a relatively stable and robust part. The corresponding holding and mounting forces can therefore advantageously be absorbed by said component of the module. In particular this allows the axially fixed end position of the module in the housing slot to be particularly advantageously reached and maintained.

In one exemplary embodiment the positioning device has axial guide channels on the inner face. In particular the printed circuit board of the module engages in said guide channels. This is a further extremely advantageous exemplary embodiment, as said guide channels allow targeted and straight guidance on the mounting path of the module in the housing slot to the end position in the housing slot. If the printed circuit board is already engaged in the guide channels, the end position can be reached in a very direct and efficient manner. The guide channels therefore serve both to maintain and support the final end position of the module in the housing slot as well as to guide the module to said end position in a defined manner.

In one exemplary embodiment the positioning device has an axial stop. This is configured on the inner face of the housing slot. In the end position one edge of the module, in particular of the printed circuit board, rests against said axial stop. This allows the axial end position of the module in the housing slot to be located particularly precisely and also to be maintained. Therefore in one advantageous exemplary embodiment said axially fixed end position can be predetermined and then maintained particularly precisely with a working connection between the guide channels and the axial stop.

In one exemplary embodiment the guide channels are configured as a single piece with the housing slot. In one exemplary embodiment the at least one axial stop is configured as a single piece with the housing slot.

In one exemplary embodiment the positioning device has an engaging element arranged on the inner face of the housing slot. Said engaging element engages in a counter engaging element configured on an edge of the printed circuit board to secure the axial position of the printed circuit board and therefore to define the end position of the printed circuit board in the housing slot. In one exemplary embodiment the arrangement of the housing slot with the module therefore also has a snap-fit connection. This is formed by the engaging element and the counter engaging element. This allows the axial position of the module in the housing slot to be fixed in both directions along the longitudinal axis. This is a particularly advantageous embodiment.

Provision can be made for the engaging element to be configured in a guide channel.

Generally in one exemplary embodiment the positioning device establishes the positionally secure end position of the module in the housing slot in all three spatial directions. This can be achieved in particular by the guide channels and said snap-fit connection. The guide channels preferably allow secure positioning in both spatial directions perpendicular to the longitudinal axis here. The snap-fit connection allows secure positioning in particular at least in the direction of the longitudinal axis.

In one exemplary embodiment the delimiting contour of the counter engaging element is angled, in particular at a 45° angle. When the module is inserted into the housing slot along the longitudinal axis of the housing slot therefore the engaging element attains said angle or chamfer and can therefore snap easily into the engaging element.

A snap fit is therefore also possible when the wall, on which the engaging element is molded as a single piece on the inner face of the housing slot, is relatively rigid.

In one exemplary embodiment the module is arranged in particular in a central third of the length of the housing slot when viewed along the longitudinal axis of the housing slot. Provision can be made for said module to be arranged in the center of the housing slot when viewed along the longitudinal axis. In one exemplary embodiment therefore the coupled state between the first electrical connector of the camera and a further second electrical connector external to the camera is also arranged, in particular arranged in its totality, in the housing slot of the camera. This automatically results in a protected connector connection, which is positioned, in particular in its totality, in the housing slot, when the camera is in its mounted end state in the housing slot. This configuration also results in the mechanically stable positioning of said connector connection in the mounted end state.

In one exemplary embodiment the housing of the camera has a front part that is separate from the housing slot. In one exemplary embodiment said housing slot is connected to the front part by at least one snap-fit connection. Such a specific non-destructively releasable mechanical connection can be established easily. It can then also be released easily as required for maintenance purposes or the like. Because the housing is formed from at least two separate components, the mounting of individual parts of the camera can be achieved in a more individual and efficient manner both in the housing slot and in the front part. This allows more precise positioning of the individual components in both parts of the housing. And access to the individual components incorporated in these two housing parts is also improved.

In one exemplary embodiment the housing slot is configured as straight and tubular. In particular it can be a square tube. In the exemplary embodiment the basic geometry of the housing slot is configured symmetrically to a plane running perpendicular to the longitudinal axis of the housing slot. The opposing ends of the housing slot can therefore be of equal size. Such a configuration results one the one hand in a relatively simple housing part, which can also hold corresponding components and allows mechanically stable connection to parts external to the camera. It is also correspondingly mechanically stable and durable. Therefore in one exemplary embodiment a further coupling to housing parts of the camera can also be established in a simple manner. This can be for example a separate front part and/or in a further exemplary embodiment an additional separate curved segment of the camera housing. This easily provides a correspondingly wide number of variants for the configuration of different camera types.

In one exemplary embodiment the housing slot is made of plastic. It can be an injection molded part for example.

In one exemplary embodiment the camera housing has a front part that is separate from the housing slot. An image capturing module of the camera is arranged in said front part. In one advantageous exemplary embodiment said image capturing module is held in the front part by at least one snap-fit connection. This results in a simple and fast mounting scenario for said image capturing module in the front part. It also allows reliable position fixing and a high level of positional precision.

In one exemplary embodiment the image capturing module has a printed circuit board. In one exemplary embodiment said printed circuit board is snap-fitted in the front part by at least one snap-fit connection that interacts mechanically in a direct manner with the printed circuit board. The printed circuit board forms a mechanically stable and durable part here too. It can easily absorb and continuously maintain the corresponding mounting and holding forces. The resulting fixed positioning is therefore also continuously maintained in respect of the positional precision of the image capturing module.

In one exemplary embodiment the image capturing module has a printed circuit board. It is connected to the printed circuit board of the module by a flexible ribbon conductor or a flexible conductor board.

This allows the different printed circuit boards that are incorporated in the camera housing some distance from one another to be connected directly electrically in a simple and space-saving manner.

In one exemplary embodiment the printed circuit board of the image capturing module and the printed circuit board of the module with the first electrical connector can be supplied as a pre-mounted assembly together with said flexible ribbon conductor. This pre-mounted assembly can then subsequently be incorporated first in the housing slot. In particular this incorporates the printed circuit board of the module in the housing slot with its position fixed axially, in particular its position fixed in all three spatial directions. The printed circuit board of the image capturing module is then subsequently incorporated, in particular snap-fitted, in the front part of the camera housing that is separate and is preferably present. This configuration allows a particularly simple and fast mounting scenario.

In one exemplary embodiment the camera housing has a separate, hollow curved segment. In one exemplary embodiment this is arranged between the front part on the one hand and the housing slot on the other hand when viewed in the direction of the longitudinal direction of the housing. The curved segment is configured in particular as an angular position adapter for the front part. The curved segment is connected in a non-destructively releasable manner to both the front part and the housing slot. The entire housing is then formed by the parts arranged in series with one another comprising the housing slot, the curved segment and the front part. Said curved segment therefore makes it possible to set a specific orientation of the capture range of the image capturing module. It is then possible with this exemplary embodiment with the curved segment for a main axis of the capture range of the image capturing module to be oriented at an angle to the longitudinal axis of the housing slot. This angle is greater than 0° and smaller than 180°. In particular it can be between 100° and 170°.

In one exemplary embodiment said curved segment is connected to the front part by at least one snap-fit connection. In one advantageous exemplary embodiment it is connected to the housing slot at least by one snap-fit connection. This allows a wide range of housing parts of the camera housing to be put together quickly and individually. It also allows a wide range of options for producing diverse individual camera variants. This modular structure of the camera housing allows a diverse number of housing variants to be achieved with a number of identical parts. An individual housing variant can therefore be produced easily and quickly for different applications and different incorporation situations. Said housing parts are outer parts and therefore visible parts.

A further aspect of the invention relates to a household refrigeration appliance as an exemplary embodiment of a household appliance. The household refrigeration appliance can be a refrigerator or a freezer or a combined refrigerator/freezer appliance. The household refrigeration appliance is configured to store and conserve food. It can have a chamber in the form of a refrigeration compartment or a freezer compartment. Both chambers are also possible in one exemplary embodiment. A chamber is delimited by walls of an inner container of the household refrigeration appliance. Such an inner container is generally made of plastic. It is part of a housing of the household refrigeration appliance. The housing of the household refrigeration appliance also has an outer housing, which is separate from the inner container. The inner container is held in the outer housing. A thermally insulating material is introduced in a space between the outer housing and the inner container. This can be thermally insulating foam in particular. A door of the household refrigeration appliance can also have a wall, which is an inner wall. The door can also have an outer wall. A thermally insulating material is introduced into a space between the inner wall and the outer wall.

In the mounted state provision is made for at least sections of a separate backing part to be arranged in an above-mentioned space between an outer part and an inner part. At least a contact plate thereof is positioned in this space. The contact plate is in contact in particular with a rear face of said wall or inner wall facing the space. When the household refrigeration appliance is in the mounted state the thermally insulating material is in direct contact with said backing part. The camera can be arranged on a wall of the household refrigeration appliance. In particular on an inner wall. When a door of the household refrigeration appliance is in a closed state, it can delimit the chamber. The inner wall can be an inner wall of the door. However it can also be a wall of the inner container. It can also be arranged on a wall, which is arranged in the chamber and is not part of the inner container.

This arrangement with the camera and backing part can thus be arranged on a wall of an inner container of the household refrigeration appliance. However the wall of the household refrigeration appliance can also be part of a door of the household refrigeration appliance for example. This can be the inner lining of the door for example. This is an example of an inner part. When the door is in the closed state, the inner lining faces the chamber of the household refrigeration appliance. This inner lining is also a visible part of the door. A space between an outer part in the form of an outer lining and an inner lining of the door can also be delimited thereby. Thermally insulating material can also be introduced into this space.

A further independent aspect of the invention relates to a method for mounting a camera of a household appliance. In particular the household appliance is configured according to the above-mentioned aspect of an advantageous exemplary embodiment thereof. The method has the following steps:
supplying a housing slot of a camera housing;
supplying a module that is separate from the housing slot and has a first electrical connector;
inserting the module into the housing slot;
moving the module axially in the housing slot in the direction of a predefined end position of the module in the housing slot;
coupling the module mechanically to the positioning device, which is configured on an inner face of the housing slot, so that the module is at least axially fixed in the end position in the housing slot.

The advantages achieved with this mounting method have already been set out above in relation to the household appliance. They apply in the same way here.

In one exemplary embodiment of the invention the pre-mounted assembly is produced, as set out above. In one exemplary embodiment said pre-mounted assembly is then inserted into the housing slot. To this end the pre-mounted assembly is inserted into the housing slot from one end of the housing slot with the printed circuit board of the image capturing module in front. The printed circuit board of the module with the first electrical connector is therefore inserted last into the housing slot. The printed circuit board of the image capturing module is preferably smaller than the printed circuit board of the module. This in particular allows the printed circuit board of the image capturing module to pass the positioning device in the housing slot easily and exit again at the opposite end in the direction of the longitudinal axis of the housing slot. The printed circuit board of the module is introduced into the housing slot, as set out above, until it reaches the defined and desired axial end position in the housing slot and is fixed there axially as required. This means in particular that it can no longer move in both directions along the longitudinal axis. In particular the printed circuit board is held in position by at least one snap-fit connection. In particular a positioning lug is configured, which has a counterpart in the printed circuit board, producing the snap-fit connection in the coupled state.

In one advantageous further mounting step the printed circuit board of the image capturing module is incorporated in the front part of the camera housing that is preferably present. A mechanical snap-fit connection is used here in particular so that said printed circuit board is snap-fitted in the front part. If a variant of the camera is mounted, in which a curved housing segment is to be present, in addition to the front part and the housing slot, said curved segment is supplied and the printed circuit board of the image capturing module, which has been passed out of the housing slot again, is passed through the curved segment so that said printed circuit board of the image capturing module exits from the curved segment again. A camera with a curved segment as part of the housing is advantageous in particular when it is mounted on an inner face of a door of the household refrigeration appliance, as the camera can still capture an image in the chamber even when the door is open.

The curved segment is connected mechanically, in particular by means of a snap-fit connection, to the housing slot before or afterwards. If the printed circuit board of the image capturing module is incorporated, specifically in particular snap-fitted, in the front part, the front part is either fastened mechanically to the housing slot in a direct manner, in particular by at least one snap-fit connection, or, if the curved segment is present, fastened mechanically to the curved segment in a direct manner, in particular snap-fitted thereto. Said camera unit is then arranged for example on a wall of the household appliance. In particular a backing part can be supplied for this, which is arranged on the opposite face of the wall to the camera. In one exemplary embodiment said backing part can extend through a hole or opening in the wall. In particular the housing of the camera, in particular the housing slot, is then connected mechanically in a direct manner to said backing part. In one advantageous exemplary embodiment only one or multiple snap-fit connections is/are provided. When the housing slot is connected thus to said backing part, the direct electrical connection between the first electrical connector and the second electrical connector mounted on the backing part is automatically established.

A further independent aspect of the invention relates to a household appliance with a camera. The camera has a housing and a module separate from the housing. The module is arranged in the housing. The housing has a housing slot and a separate curved segment. As a result the entire housing is formed by the curved segment with an angular part. The curved segment and the housing slot are connected in a non-destructively releasable manner. In particular they are connected directly to one another by at least one snap-fit connection.

Advantageous exemplary embodiments of the above-mentioned aspect should be considered to be advantageous exemplary embodiments of the further independent aspect.

The terms “top”, “bottom”, “front”, “rear”, “horizontal”, “vertical”, “depthwise direction”, “widthwise direction”, “heightwise direction”, etc. refer to the positions and orientations resulting when the appliance is used and positioned in the correct manner.

Further features of the invention will emerge from the claims, figures and description of the figures. The features and feature combinations cited above in the description as well as the features and feature combinations cited in the following in the description of the figures and/or shown in the figures alone can be used not only in the respectively cited combination but also in other combinations or alone, without departing from the scope of the invention. Therefore embodiments of the invention which are not specifically shown and explained in the figures but will emerge and can be generated from the described embodiments as a result of separate feature combinations are also deemed to be covered and disclosed by the invention. Embodiments and feature combinations which do not therefore have all the features of an originally formulated independent claim should also be deemed to be disclosed.

Exemplary embodiments of the invention are described in more detail below with reference to schematic drawings, in which:

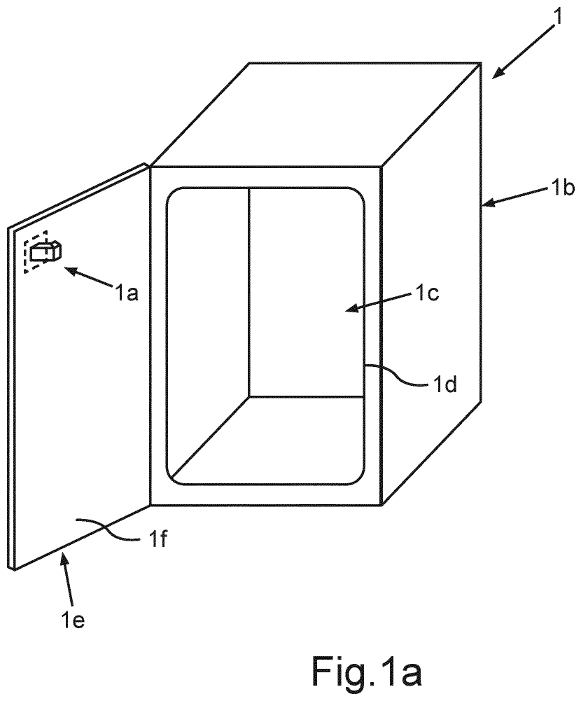

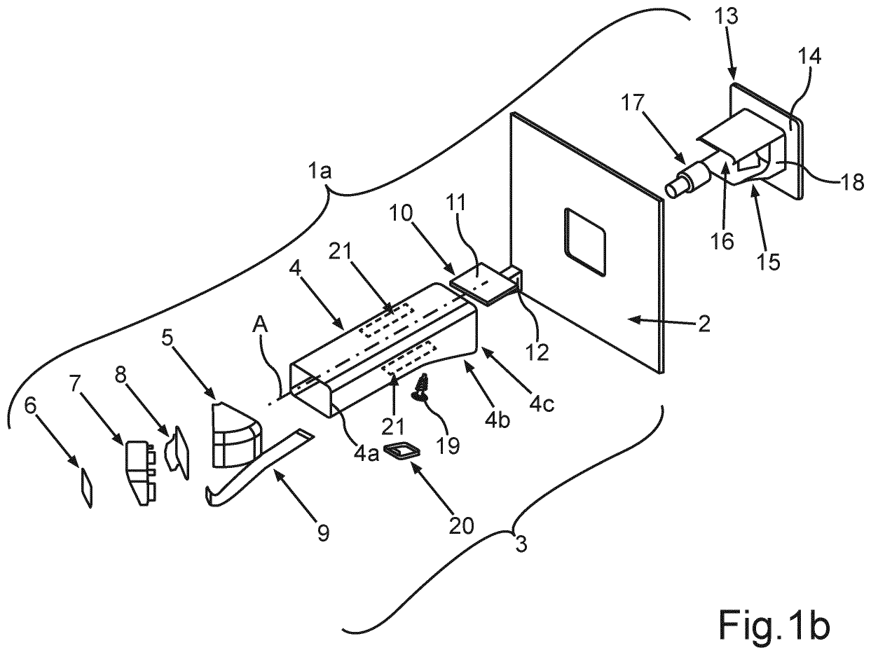

FIG. 1a shows a schematic view of an exemplary embodiment of a household appliance;

FIG. 1b shows an exploded view of an exemplary embodiment of an arrangement with an exemplary embodiment of a camera and with a backing part;

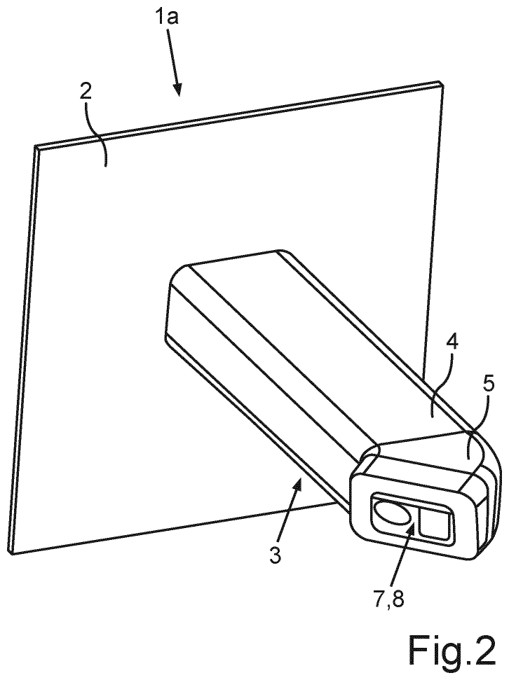

FIG. 2 shows the arrangement from FIG. 1b in the assembled state;

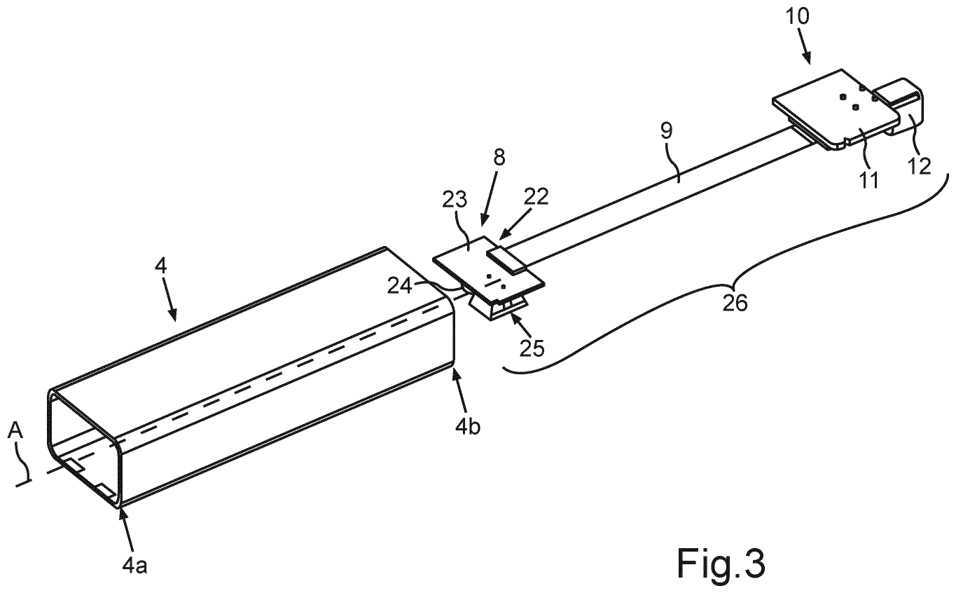

FIG. 3 shows a view of sub-components of a camera of the household appliance from FIG. 1a or FIG. 1b in an intermediate mounting state;

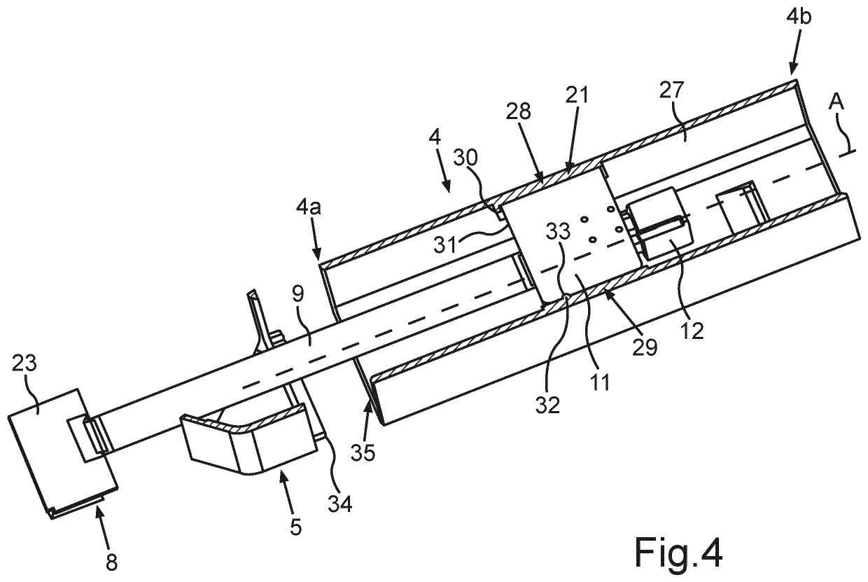

FIG. 4 shows a perspective sectional view through components of the camera for the household appliance in an intermediate mounting state following FIG. 3;

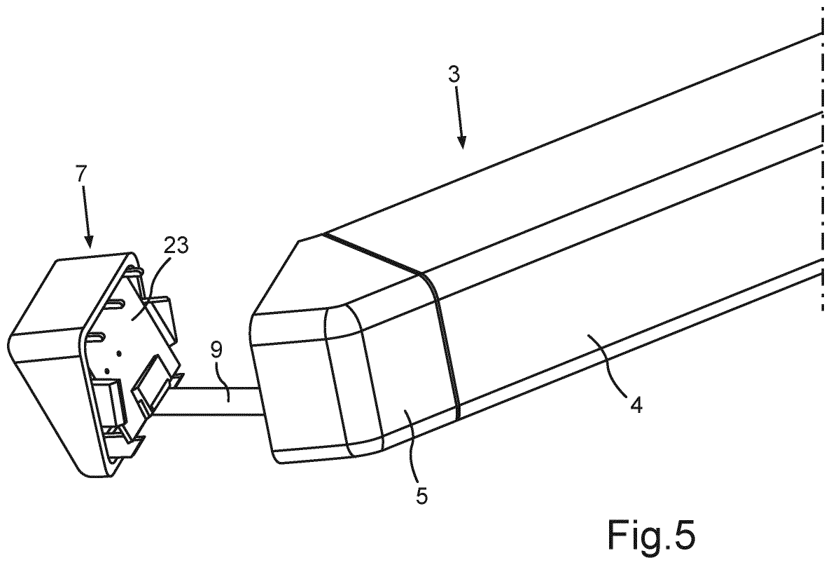

FIG. 5 shows a perspective view of sub-components of the camera for the household appliance in a further intermediate mounting state following FIG. 4;

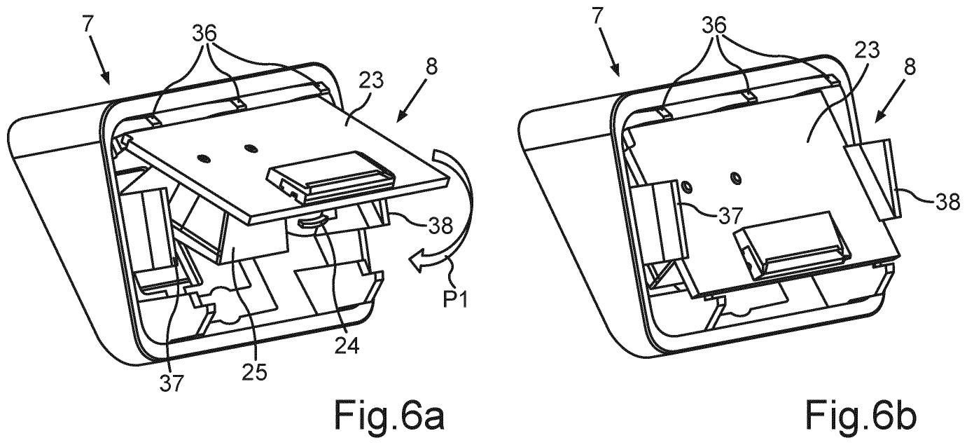

FIG. 6a shows a perspective view of the mounting of a printed circuit board of an image capturing module of the camera on a front part of a housing of the camera;

FIG. 6b shows the mounted end state of the printed circuit board on the front part;

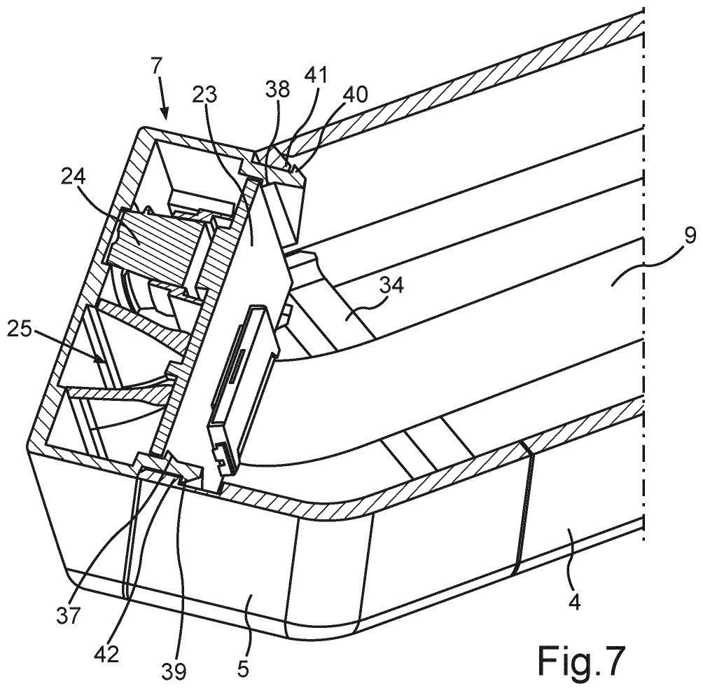

FIG. 7 shows a perspective view of the mounted end state of the front part from FIG. 6b on the further housing components of the housing of the camera;

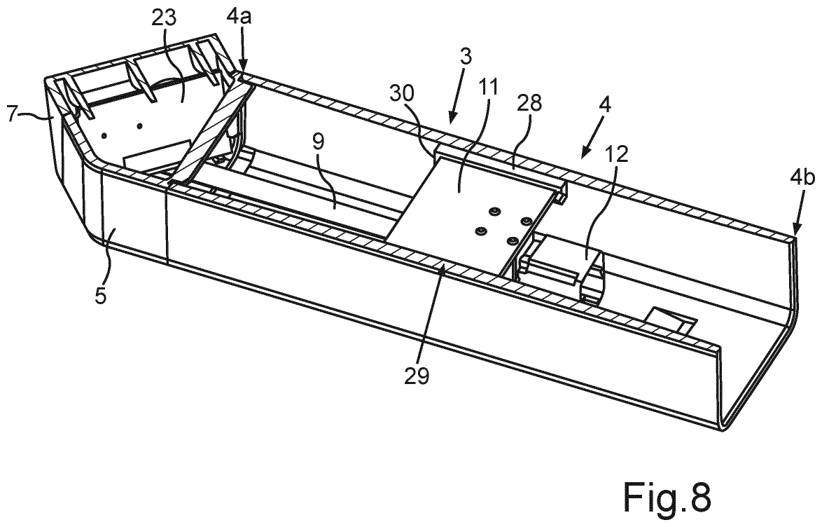

FIG. 8 shows a perspective sectional view of the assembled camera;

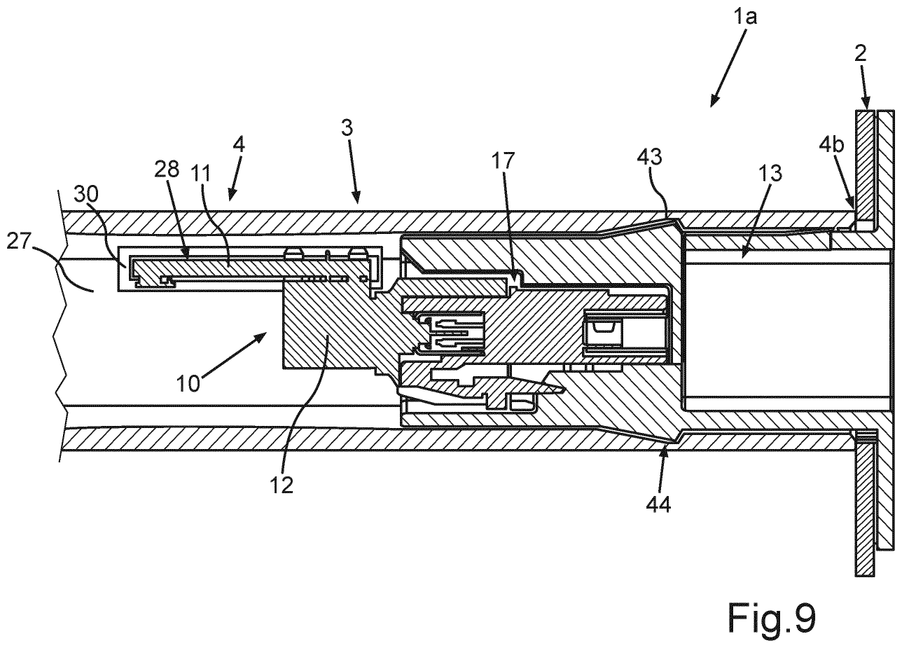

FIG. 9 shows a sectional view of the mounted state of the camera on a backing part and a wall of the household appliance; and

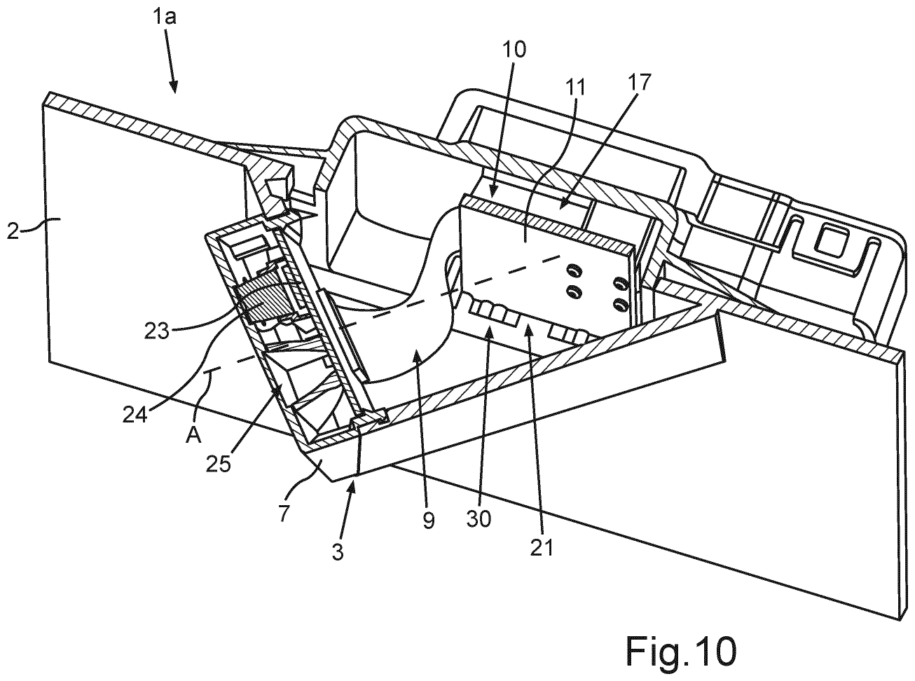

FIG. 10 shows a perspective sectional view through a further exemplary embodiment of an arrangement with a camera on a wall of a household appliance and a backing part.

Identical elements or those of identical function are shown with the same reference characters in the figures.

FIG. 1a shows a schematic view of a household appliance, in this instance a household refrigeration appliance 1. The household refrigeration appliance 1 has an arrangement 1a. The household refrigeration appliance 1 has a housing 1b. A chamber 1c for holding food is configured herein. The chamber 1c can be a refrigerator compartment or a freezer compartment. The chamber 1c is delimited by walls of an inner container 1d of the household refrigeration appliance 1. The household refrigeration appliance 1 also has a door 1e. This is arranged on the housing 1b in such a manner that it can pivot to close the chamber 1c. The door 1e has a wall 1f, which is an inner lining.

FIG. 1b shows an exploded view of an exemplary embodiment of an arrangement 1a. The arrangement 1a is configured for mounting on a wall 2 of the household appliance, in particular the household refrigeration appliance 1. The wall 2 can be the wall 1f or it can be a wall of the inner container 1d. The arrangement 1a has a camera 3. The camera 3 has a housing. The housing here is made up of multiple parts. In one exemplary embodiment it has a quite long, straight housing slot 4 or a housing channel. The housing in the exemplary embodiment also has a curved segment 5. The curved segment 5 is configured to be joined to the housing slot 4. A snap-fit connection in particular is provided here. The quite long housing slot 4 has a longitudinal axis A. The connection to the curved segment 5 is provided on a front end 4a of the housing slot 4 facing away from the wall 2. The quite long housing slot 4 is rectangular in cross section. However it can be of a different shape. It can be seen that a rear end 4b of the housing slot 4 facing the wall 2 in the mounted state is configured with a widened end piece 4c. The widening here is provided below when viewed in a heightwise direction. This results in a funnel shape in the rear region of said quite long housing slot 4. In one preferred exemplary embodiment according to FIG. 1b the rear end 4b is not widened however. In particular it has the same cross section at the rear end 4b as at the front end 4a.

In one exemplary embodiment the camera 3 also has an anti-fog element 6. In particular this is a film. In one exemplary embodiment the camera 3 also has a terminating element or front part 7. This is provided to hold a module 8. The module 8 has a printed circuit board. In particular the camera 3 also has optical components and an image sensor. The front part 7 is part of the housing of the camera 3. The module 8 can also be referred to as an image capturing module 8. It can feature the image sensor. It can feature an optical system.

A flexible conductor board 9 is also provided for the camera 3. It connects the module 8 to a further module 10 of the camera 3. Said further module 10 has a printed circuit board 11. The module 10 also in particular has a first electrical connector 12. This is connected to the printed circuit board 11 or mounted thereon.

In one exemplary embodiment provision can be made for the housing of the camera 3 to feature the two components 4 and 5. In a further exemplary embodiment however provision can be made for the housing of the camera 3 also to feature the front part 7. Either configuration can be advantageous, depending on the positioning of the arrangement 1a in the household refrigeration appliance 1. In particular the curved segment 5 is advantageous when specific angles result when the door 1e of the household refrigeration appliance 1 is opened. It should in particular be possible even then to capture the entire chamber 1c of the household refrigeration appliance 1.

The camera 3 can be arranged on the door 1e of the household refrigeration appliance 1. However it can also be arranged on the inner container 1d, which delimits the chamber 1c for food. The chamber 1c is to be captured by the camera 3.

The arrangement 1a also has a backing part 13. The backing part 13 is separate from the camera 3. In one exemplary embodiment the backing part 13 is a single-piece part. It can in particular be made of plastic. In one exemplary embodiment the backing part 13 has a contact plate 14. It also has a mechanical coupling unit 15. The coupling unit 15 is arranged so that it projects from the contact plate 14. In one exemplary embodiment the coupling unit 15 has a holding slot 16. This is provided in particular to hold a second electrical connector 17.

In one exemplary embodiment the backing part 13, in particular the coupling unit 15, has an in particular widened front piece 18. This in particular complements the widened end piece 4c of the quite long housing channel 4, when said widening is present there.

FIG. 1b also shows a screw 19 for one exemplary embodiment. This is provided to establish a screw connection between the camera 3 and the backing part 13. A cover 20 is also shown. This is to cover the screw 19 when it is tightened. In one exemplary embodiment there is preferably no screw connection between the camera 3 and the backing part 13. The camera 3 is then only connected to the backing part 13 by snap-fit connections.

FIG. 1b shows that the housing slot 4 is configured as a square tube. The housing slot 4 is configured in particular as a single piece, preferably made of plastic. It is in particular an injection molded part. In one exemplary embodiment the opposing ends 4a and 4b of the housing slot 4 are configured identically. This means that the cross sections are of equal size here.

In one exemplary embodiment in particular, in which the housing slot 4 is only connected to the backing part 13 by snap-fit connections, the housing slot 4 does not feature the widened end piece 4c. The screws 19 and the cover 20 in particular are then not present. This is then the preferred exemplary embodiment.

FIG. 1b also shows a positioning device 21 symbolically. The positioning device 21 is configured in the housing slot 4. It is configured as a single piece with the housing slot 4. The positioning device 21 is provided functionally and purposefully to fix the module 10, in particular the printed circuit board 11, axially in the housing slot 4 in a defined manner. In the mounted end state the printed circuit board 11 then has an at least axially secured end position in the housing slot 4. To mount the camera 3 provision is first made for the prefabricated module 10, featuring the printed circuit board 11 and the first electrical connector 12, to be connected to the flexible conductor board 9 or the related flexible ribbon conductor. The module 8 is also connected to said flexible conductor board 9.

FIG. 2 shows the arrangement 1a in the assembled state.

Said module 8, which is an assembly 22 (FIG. 3) of the camera 3, has a printed circuit board 23. Arranged on said printed circuit board 23 is an image capturing unit 24, as also shown in FIG. 3.

In one exemplary embodiment the camera 3 also has a flash unit 25. This is preferably arranged next to the separate image capturing unit 24 on said printed circuit board 23. This component arrangement comprising said module 8, the flexible conductor board 9 and the module 10, forms a pre-mounted assembly 26. It is then supplied accordingly. It is then inserted into the housing slot 4 from the second end 4b along the longitudinal axis A. This means that in practice the module 8, in particular the conductor board 23, is inserted first into the housing slot.

As shown in the perspective sectional view in FIG. 4, the positioning device 21 is configured in an integrated manner on an inner face 27 of said housing slot 4. In one exemplary embodiment the positioning device 21 has guide channels 28 and 29. These are configured on opposing inner faces 27 of opposing walls of the housing slot 4. Said guide channels 28 and 29 are oriented axially. In the exemplary embodiment the positioning device 21 also has an axial stop 30. When the module 10 reaches its end state or end position in the housing slot 4, a rear face or edge 31 of the printed circuit board 11 is in direct contact with said axial stop 30. In one exemplary embodiment the axial stop 30 can be an end delimitation of at least one guide channel, in this instance the guide channel 28.

Additionally or alternatively the axial stop 30 can also be an end delimitation of the guide channel 29. The printed circuit board 11 is inserted directly into said guide channels 28 and 29.

In one exemplary embodiment the positioning device 21 also has an engaging element 32. This is configured as a single piece on the inner face 27. The engagement element or engaging element 32 is in particular a snap-fit element. As also shown in FIG. 4, a side edge of the printed circuit board 11 features an indentation, which forms a counter engaging element 33. When the module 10, in particular the printed circuit board 11, is in the axial end position in the housing slot 4, the engaging element 32 engages in the counter engaging element 33. This results in particular in a snap-fit connection here.

In one exemplary embodiment the positioning device 21 secures the module 10 axially in the housing slot 4 in both directions along the longitudinal axis A. The guide channels 28 and 29 in particular also allow position fixing or securing perpendicular to the longitudinal axis A.

In one exemplary embodiment the positioning device 21 arranges the module 10, in particular the printed circuit board 11, in a positionally secured manner in all three spatial directions in the housing slot 4.

As also shown in FIG. 4, from the intermediate mounting state in FIG. 3 the pre-mounted assembly 26 is inserted into the housing slot 4 such that the flexible conductor board 9 and particularly also the module 8 exit again from the housing slot 4 at the front end 4a.

If the camera 3 features a variant in which the curved segment 5 is also present, the curved segment 5 is supplied during the mounting scenario and the pre-mounted assembly 26 with the module 8 and part of the flexible conductor board 9 is also passed through the curved segment 5.

In one exemplary embodiment the curved segment 5 is snap-fitted directly to the housing slot 4, in particular the front end 4a, by at least one snap-fit connection.

At least on snap-fit element 34 and at least one counter snap-fit element 35 can be provided for this purpose.

Further to the intermediate mounting state of the camera 3 reached in FIG. 4 in an advantageous further mounting scenario the front part 7 of the housing of the camera 3 is supplied. The printed circuit board 23 is then mounted in said front part 7 as shown in FIG. 5. A non-destructively releasable connection in particular is provided here. In particular said printed circuit board 23 is held in a fixed position in the front part 7 by at least one snap-fit connection.

An enlarged view of the front part 7 is also shown in FIG. 6a. One or more delimiting lugs 36 are configured as a single piece with the front part 7 here. The conductor board 23 is brought into contact with them and pivoted in the direction of the front part 7, as shown by the arrow P1. The front part 7 has snap-fit elements 37 and 38. From the intermediate mounting state in FIG. 6a the pivoting in the direction of the arrow P1 causes the snap-fit elements 37 and 38 to be snap-fitted to the edge regions of the printed circuit board 23. This is shown in FIG. 6b. This shows the mounted end state of the module 8, in particular also of the conductor board or printed circuit board 23, in the front part 7. For the sake of clarity the flexible conductor board 9 is not shown here. The mounting state shown in FIG. 6b is also shown in FIG. 5.

From the intermediate mounting state reached in FIG. 5 the front part 7 with the module 8 mounted therein is mounting on the remaining housing parts of the housing of the camera 3. In the exemplary embodiment shown, in which the curved segment 5 is present, said front part 7 is fastened to the curved segment 5. A non-destructively releasable connection is provided here in particular. In the view in FIG. 7, which shows a perspective sectional view, at least one snap-fit connection is provided here. In one exemplary embodiment side webs of the front part 7, on which the snap-fit elements 37 and 38 are also configured, also have snap-fit elements 39 and 40. Said snap-fit elements 39 and 40 then snap-fit to corresponding counter snap-fit elements 41 and 42, which are configured on the curved segment 5.

FIG. 8 shows a perspective sectional view of the camera 3 in its mounted end state.

The camera 3 thus mounted is then fastened to the backing part 13 in a further advantageous mounting step. As shown in FIG. 9, the camera 3 is only connected to the backing part 13 by means of snap-fit connections. In one exemplary embodiment the camera 3 rests against the wall 2 at the rear end 4b. However the camera 3 can also be positioned a short distance from the wall 2. Snap-fit connections between the housing slot 4 and the backing part 13 are shown with the reference characters 43 and 44 here by way of example.

FIG. 10 shows a perspective view of a further exemplary embodiment. An axial stop 30 and/or at least one guide channel 28 and/or 29 and/or a snap-fit connection with an engaging element 32 and with a counter engaging element 33 can be configured here too. In this embodiment the housing slot 4 is not configured as a straight symmetrical square tube but as angled housing components. With this embodiment in the mounted state the longitudinal axis A of the housing slot 4 is not oriented perpendicular to the plane of the wall 2 but at an angle greater than 0° and smaller than 90°, in particular between 20° and 60°. The camera shown here can be arranged in a chamber 1c. For example it can be arranged on a wall of the inner container 1d or on a separate wall in the chamber 1c.

### LIST OF REFERENCE CHARACTERS

1 Household refrigeration appliance
1a Arrangement
1b Housing
1c Chamber
1d Inner container
1e Door
1f Wall
2 Wall
2a Cut-out
2b Rear face
2c Front face
3 Camera
4 Housing slot
4a Front end
4b Rear end
4c End piece
4d Rear edge
5 Curved segment
6 Anti-fog element
7 Front part
8 Module
9 Conductor board
10 Module
11 Printed circuit board
12 Connector
13 Backing part
14 Contact plate
15 Coupling unit
16 Holding slot
17 Connector
18 Front piece
19 Screw
20 Cover
21 Positioning device
22 Assembly
23 Printed circuit board
24 Image capturing unit
25 Flash unit
26 Pre-mounted assembly
27 Inner face
28 Guide channel
29 Guide channel
30 Axial stop
31 Edge
32 Engagement element
33 Counter engaging element
34 Snap-fit element
35 Counter snap-fit element
36 Delimiting lug
37 Snap-fit element
38 Snap-fit element
39 Snap-fit element
40 Snap-fit element
41 Counter snap-fit element
42 Counter snap-fit element
43 Snap-fit connection
44 Snap-fit connection
x Widthwise direction
y Heightwise direction
A Longitudinal axis
P1 Arrow

1-15. (canceled)

16. A household appliance, comprising:
a camera having a housing, said housing having a housing slot with a longitudinal axis;
a module with a first electrical connector, said module being distinct from said housing and being arranged in said housing; and
a positioning device arranged on an inner face of said housing slot, said positioning device fixing said module at least axially in said housing slot.

17. The household appliance according to claim 16, wherein said module comprises a printed circuit board, which is mechanically connected directly to said positioning device so that said printed circuit board is axially fixed in said housing slot.

18. The household appliance according to claim 17, wherein said positioning device comprises axial guide channels on said inner face, and said printed circuit board engages in said axial guide channels.

19. The household appliance according to claim 17, wherein said positioning device is formed with an axial stop on said inner face and said printed circuit board has an edge resting against said axial stop.

20. The household appliance according to claim 17, wherein said positioning device has an engaging element arranged on said inner face and engages in a counter engaging element on an edge of said printed circuit board to secure the axial position of said printed circuit board.

21. The household appliance according to claim 16, wherein said module is disposed in an axial center of said housing slot.

22. The household appliance according to claim 16, wherein said housing slot is formed as a straight and tubular opening.

23. The household appliance according to claim 22, wherein said housing slot is formed as a straight, tubular, and square tube.

24. The household appliance according to claim 16, wherein said housing has a front part that is separate from said housing slot and is connected to said housing slot by at least one snap-fit connection.

25. The household appliance according to claim 16, wherein said housing has a front part that is separate from said housing slot, and further comprising an image capturing module of said camera arranged in said front part and held in said front part by at least one snap-fit connection.

26. The household appliance according to claim 25, wherein said image capturing module has a printed circuit board, which is snap-fitted in said front part by said at least one snap-fit connection that interacts mechanically and directly with said printed circuit board.

27. The household appliance according to claim 25, wherein:
said module comprises a printed circuit board, which is mechanically connected directly to said positioning device so that said printed circuit board is axially fixed in said housing slot;
said image capturing module has a printed circuit board, which is connected to said printed circuit board of said module by a flexible conductor board.

28. The household appliance according to claim 24, wherein said housing further has a separate curved segment, which is arranged between said front part and said housing slot and which is configured as an angular position adapter for said front part, and wherein said curved segment is connected non-destructively and releasably to said front part and to said housing slot.

29. The household appliance according to claim 28, wherein said curved segment is connected to said front part by at least one snap-fit connection and connected to said housing slot by at least one snap-fit connection.

30. The household appliance according to claim 16, configured as a household refrigeration appliance.

31. A method for mounting a camera of a household appliance, the method comprising:
providing a housing of the camera with a housing slot;
providing a module that is separate from the housing slot and has a first electrical connector;
inserting the module into the housing slot;
moving the module axially in the housing slot towards of a predefined end position of the module in the housing slot; and
mechanically coupling the module to a positioning device, which is configured on an inner face of the housing slot, to thereby fix the module at least axially in an end position in the housing slot.

32. The method according to claim 31, which comprises assembling a household appliance with:
a camera having a housing, the housing having a housing slot with a longitudinal axis;
a module with an electrical connector, the module being distinct from the housing and being arranged in the housing; and
a positioning device arranged on an inner face of the housing slot and fixing the module in the housing slot.
